(19) United States
(12) Patent Application Publication
(10) Pub. No.: US 2022/0314961 A1
(43) Pub. Date: Oct. 6, 2022

(54) Power Train Support System, Vehicle, and Method for Operating a Power Train Support System in a Vehicle

(71) Applicants: Hyundai Motor Company, Seoul (KR); Kia Corporation, Seoul (KR)

(72) Inventors: Esteve Josa Farran, Grossostheim (DE); Urs Schiel, Laudenbach (DE); David Schulz, Bischofsheim (DE); Florent Larrosa, Hohenstein Breithard (DE); Burak Ulas, Mainz (DE)

(21) Appl. No.: 17/370,194

(22) Filed: Jul. 8, 2021

(30) Foreign Application Priority Data
Mar. 30, 2021 (DE) 102021203213.3

(51) Int. Cl. B60W 20/40; B60K 6/26

(52) U.S. Cl. CPC B60W 20/40; B60K 6/26

(57) ABSTRACT

An embodiment power train support system includes a support frame including a support structure configured to support a power train with respect to a vertical direction and a first connection interface, and a mounting device including a mounting interface at which the mounting device is mounted to a carrier part of a vehicle, a second connection interface mechanically connected to the first connection interface of the support frame, and an actuation device configured to move the second connection interface relative to the mounting interface along the vertical direction.

### CROSS-REFERENCE TO RELATED APPLICATIONS

This application claims the benefit of German Patent Application No. 102021203213.3, filed on Mar. 30, 2021, which application is hereby incorporated herein by reference.

### TECHNICAL FIELD

The present invention relates to a power train support system for a vehicle, to a vehicle, and to a method for operating a power train support system in a vehicle.

### BACKGROUND

A power train of a vehicle usually includes an engine and a transmission and is mounted to a power train support frame. The power train support frame typically is mounted to a chassis of the vehicle via a frame mount.

As the power train's components, engine and transmission typically contribute remarkably to the total weight of the vehicle, the power train's position with respect to a vertical direction, i.e. the direction of gravity, influences a position of the center of gravity (COG) of the vehicle. In order to improve driving stability of the vehicle, e.g. during cornering or braking maneuvers, it would be desirable to position the COG of the vehicle as low as possible. However, the vertical position of the drive train is limited by a required minimum clearance between the ground and the power train support frame.

### SUMMARY

The present invention relates to a power train support system for a vehicle, to a vehicle, and to a method for operating a power train support system in a vehicle. Particular embodiments relate to a street vehicle such as an automobile.

An embodiment of the invention provides an improved power train support system.

Therefore, embodiments of the present invention provide a power train support system, a vehicle, and a method.

These and further embodiments of the present invention are described in the following description, referring to the drawings.

According to a first embodiment of the invention, a power train support system for a vehicle comprises a support frame comprising a support structure for supporting a power train with respect to a vertical direction and a first connection interface, and a mounting device comprising a mounting interface for mounting the mounting device to a carrier part of the vehicle, a second connection interface mechanically connected to the first connection interface of the support frame, and an actuation device configured to move the second connection interface relative to the mounting interface along the vertical direction.

According to a second embodiment of the invention, a vehicle, e.g. a street vehicle such as an automobile, comprises a carrier part, which may, for example, be formed by a chassis or a vehicle body, a power train support system according to the first embodiment of the invention, the mounting interface being coupled to the carrier part, a power train including an engine and a transmission kinematically coupled to the engine, the power train being mounted to the support structure of the support frame, and two or more wheels kinematically coupled to the power train.

A third embodiment of the invention provides a method for operating a power train support system in a vehicle according to the second embodiment of the invention. The method includes issuing an actuation signal to the actuation device of the power train support system and moving the second connection interface relative to the mounting interface along the vertical direction by means of the actuation device in accordance with the actuation signal.

One of the principles on which embodiments of the invention are based is that a power train is movable relative to a carrier part of the vehicle, i.e. the chassis or the vehicle body, in order to lower or raise a center of gravity (COG) of the vehicle. To move the power train in a vertical direction, which may be parallel to the direction of gravity when the vehicle's wheels are on a horizontal ground, a support frame for supporting the power train is movably coupled to a mounting device which is configured for being fixed to the carrier part. In particular, the mounting device includes a mounting interface, e.g. a flange or similar, a second connection interface or interconnection interface to which a first connection interface of the support frame is coupled, and an actuation device. The first connection interface of the support frame and the second connection interface of the mounting device are mechanically fixed to each other so that a distance between these interfaces remains fixed or constant. The actuation device may include an actuator kinematically coupled to the second interconnection interface and a drive mechanism for driving the actuator such that the actuator moves the second connection interface along the vertical direction relative to the mounting interface.

It is one of the advantages of embodiments of the invention that the power train support frame can easily be moved relative to a connection point provided for fixing the mounting device to the vehicle body or chassis in the vertical direction. Thereby, when the power train support system is assembled in a vehicle, the COG of the vehicle can be adjusted, i.e. lowered in order to improve dynamic driving performance of the vehicle and raised, e.g. when road conditions require a greater clearance between the support frame and the road surface.

According to some embodiments, the actuation device may comprise an electric motor and a cam coupled to the electric motor so as to be rotatable about a rotational axis, the cam including an actuation surface in contact with a contact surface of the second connection interface, wherein the actuation surface has a shape such that a distance in the vertical direction between the rotational axis and the contact surface varies upon rotation of the cam about the rotational axis. In this embodiment, the electric motor forms the drive mechanism and the cam forms the actuator. One advantage of this configuration is that the electric motor allows for a fast response of the system. In particular, by rotating the cam, high forces can be generated with relatively low driving torque, depending on the shape of the actuation surface of the cam. Finally, a dynamic adjustment of the vertical position of the support frame can easily be realized.

According to some embodiments, the second connection interface may include an elastically deformable holding member, wherein the actuation device is configured to deform the holding member to move the second connection interface along the vertical direction. The holding member may, for example, be made of a rubber material. Optionally, the holding member may have a substantially trapezoidal or conical cross-sectional shape. The actuator, e.g. the cam, may deform or compress the holding member such that it is moved along the vertical direction. For example, the actuator and the first connection interface of the support frame may be arranged on opposite sides of the holding member with regard to the vertical direction so that the actuator can push the second interface in the vertical direction. The elastically deformable properties of the holding member provide the benefit that, on the one hand, vibrations are advantageously damped, and that, on the other hand, a wear resistant movable interface is realized.

According to some embodiments, the holding member may be deformable by the actuation device from a relaxed state, in which the second connection interface is positioned relative to the mounting interface at a first distance with respect to the vertical direction, to a tensioned state, in which the second connection interface is positioned relative to the mounting interface at a second distance with respect to the vertical direction. For example, the holding member may be compressed by the actuator device to assume the tensioned state, so that the second distance is smaller than the first distance. Of course, it would also be possible that the holding member may be stretched by the actuator device to assume the tensioned state, so that the second distance is greater than the first distance. In the tensioned state, the actuation device applies a force to the holding member which acts contrary to the elastic force of the holding member. Consequently, when the force applied by the actuation device is removed, the holding member automatically assumes the relaxed state. Thereby, dynamic variation of the vertical position of the second connection interface and, consequently, of the support frame can advantageously be realized.

According to some embodiments, the first connection interface and the second connection interface may be connected to each other by a shaft. For example, the first and second connection interfaces may be provided with a hole or bore, in which the shaft can be introduced and fixed, e.g. by a threaded connection. For example, the optional holding member of the second connection interface may comprise a hole, in which the bolt is fixed, e.g. adhesively fixed or bonded to the rubber material, and the first connection interface may have a through hole, through which the bolt extends, and where it is fixed by means of a nut. The bolt provides the advantage that a predefined axial distance between the first and the second connection interfaces can be provided.

According to some embodiments, the power train support system may comprise a controller configured to receive an input signal and to issue an actuation signal to actuate the actuation device in accordance with the input signal. The controller may be an electronic controller. For example, the controller may include a processor, such as a CPU, an ASIC, an FPGA or similar, and a data memory readable by the processor, e.g. a non-volatile memory such as a solid state drive (SSD) or a hard drive (HD) memory. The memory may store software which causes the processor to issue an output signal, i.e. the actuation signal, based on one or more input signals.

According to some embodiments, the power train support system may comprise an optical sensor, for example a camera, connected to the controller, the optical sensor being configured to detect surface features, such as recesses or elevations, representing unevenness of a road surface and to provide detection data representing the detected surface features as an input signal to the controller. That is, the controller receives detection data from the optical data which represents a condition of the road surface. The controller is configured to issue an actuation signal to actuate the actuation device in accordance with the input signal, wherein the controller may be configured, for example, to issue an actuation signal which causes the actuation device to move the second connection interface such that a clearance between the road surface and the support frame is increased, when unevenness of the road surface exceeds a threshold. Thereby, an automated adjustment of the vertical position of the support frame which protects the support frame can easily be realized.

According to some embodiments, the power train support system may comprise an acceleration sensor unit connected to the controller, the acceleration sensor unit being configured to detect a lateral acceleration and to provide acceleration data representing the detected lateral acceleration as an input signal to the controller, the lateral acceleration including an acceleration along a lateral direction perpendicular to the vertical direction and/or an acceleration around a vertical axis parallel to the vertical direction. The controller may be configured to issue the actuation signal only when the detected acceleration is below a predetermined acceleration threshold. The lateral acceleration represents a roll and yaw moment acting on the system or the vehicle. When the captured lateral acceleration is too high, the controller avoids that the actuation device is operated to move the second connection interface. Thereby, a variation of the COG is avoided in situations in which high lateral forces are acting on the system. Consequently, driving safety and comfort of a vehicle having the power train support system is improved.

According to some embodiments, the power train support system may comprise an input device connected to the controller and configured to receive a driver's input representing a desired position of the second connection interface relative to the mounting interface and issue an input signal corresponding to the driver's input. For example, the driver can select between various modes representing pre-stored vertical positions of the second connection interface relative to the mounting interface, or the driver can enter a specific desired position via the input device. The input device may include a display, e.g. a touch display through which the driver can make the input, a rotatable selection wheel or similar.

According to some embodiments, the method may include receiving a driver's input representing a desired position of the second connection interface relative to the mounting interface via an input device, and issuing an input signal corresponding to the driver's input by the input device, wherein the actuation signal is issued in accordance with the input signal.

According to some embodiments, the method may include capturing a lateral acceleration of the vehicle, the lateral acceleration including an acceleration along a lateral direction perpendicular to the vertical direction and/or an acceleration around a vertical axis relative to the vertical direction, wherein the actuation signal is issued only when the detected acceleration is below a predetermined acceleration threshold.

According to some embodiments, the method may include detecting surface features, such as recesses or elevations, representing unevenness of a road surface ahead of the vehicle, wherein the actuation signal is issued based on the detected surface features.

According to some embodiments, the method may include that the actuation device moves the second connection interface such that the support frame is moved away from the road surface, when the detected surface features indicate unevenness above a predefined threshold.

The herein described features for the power train support system are also disclosed for the method and vice versa. In particular, the optional controller of the power train support system may be configured to cause the system to perform the steps of the method.

### BRIEF DESCRIPTION OF THE DRAWINGS

For a more complete understanding of embodiments of the present invention and advantages thereof, reference is made to the following description taken in conjunction with the accompanying drawings. The invention is explained in more detail below using exemplary embodiments, which are specified in the schematic figures, in which:

FIG. 1 shows a block diagram of a vehicle according to an embodiment of the invention;

FIG. 2 shows a cross-sectional view of a power train support system according to an embodiment of the invention, wherein the system assumes a first state;

FIG. 3 shows a cross-sectional view of the power train support system of FIG. 2, wherein the system assumes a second state;

FIG. 4 shows a top view of a mounting device of the power train support system of

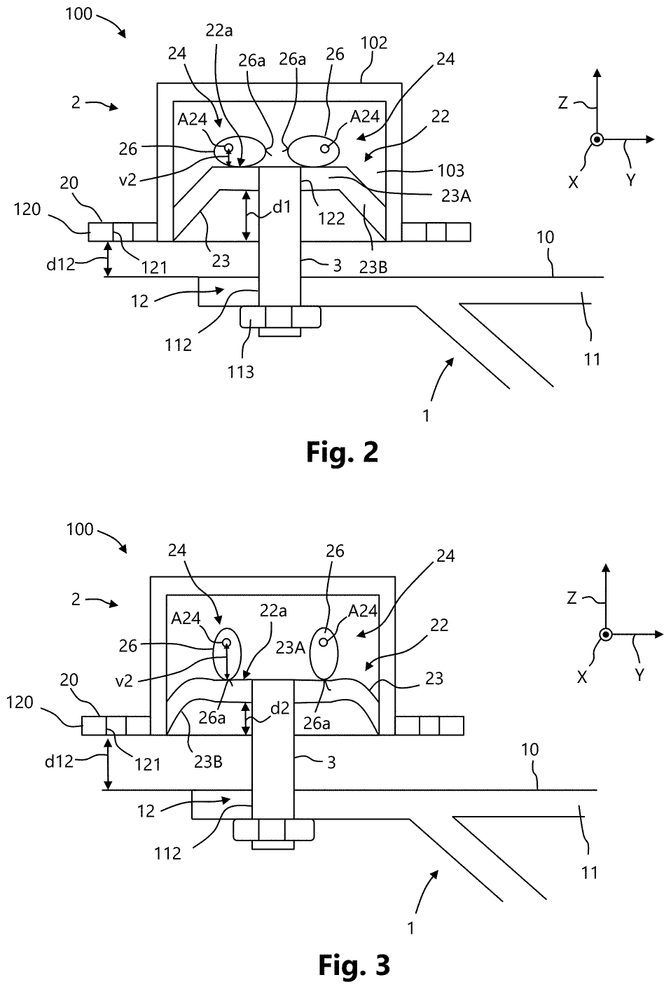

FIG. 2;

FIG. 5 shows a top view of a power train support system according to an embodiment of the invention;

FIG. 6 shows a top view of a vehicle according to an embodiment of the invention; and

FIG. 7 shows a flowchart of a method according to an embodiment of the invention.

Unless indicated otherwise, like reference signs to the figures indicate like elements.

The following elements may be used in connection with the drawings to describe embodiments of the present invention.

support frame

1A first support frame

1B second support frame

2 mounting device

3 shaft

4 controller

10 support structure

12 first connection interface

20 mounting interface

22 second connection interface

22a contact surface

23 holding member

23A plate portion

23B side portion

24 actuation device

25 electric motor

26 cam

26a actuation surface

42 optical sensor

44 acceleration sensor unit

46 input device

100 power train support system

102 housing

112 through hole

120 flange portion

121 through hole

122 opening

200 vehicle

210 chassis

220 power train

222 engine

224 transmission

230 wheels

231 first axle

232 second axle

300 road

300a road surface

A24 rotational axis

d1 first distance

d2 second distance

G direction of gravity

M method

M1-M7 method steps

v2 distance between rotational axis and contact surface

X longitudinal direction

Y lateral direction

Z vertical direction/axis

### DETAILED DESCRIPTION OF ILLUSTRATIVE EMBODIMENTS

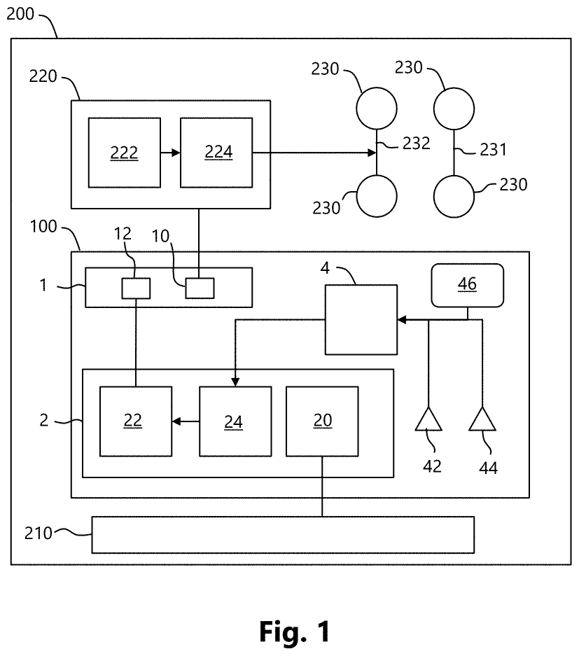

FIG. 1 exemplarily shows a block diagram of a vehicle 200. The vehicle 200 may, for example, be a street vehicle such as an automobile. As shown in FIG. 1, the vehicle 200 comprises a chassis 210, a power train support system 100, a power train 220, and wheels 230.

As is exemplarily shown in FIG. 1, the vehicle 200 may include four wheels 230, wherein two wheels 230 are coupled to a first axle 231 and the two other wheels 230 are coupled to a second axle 232. Generally, the vehicle 200 includes at least two wheels 230. The axles 231, 232 or generally the wheels 230 may be coupled to or suspended from the chassis 210.

The power train 220 comprises an engine 222 and a transmission 224. The engine 222 may be an internal combustion engine or an electrical motor. An output shaft (not shown) of the engine 222 is coupled to an input shaft (not shown) of the transmission 224 which is configured to translate the torque delivered from the output shaft of the engine 222 to the input shaft. At least one of the at least two wheels 230 is kinematically coupled to an output shaft (not shown) of the transmission 224. For example, the wheels 230 of the first axle 231 may be coupled to the transmission 224 and, therefore, are driven by the engine 222.

The power train 220 is supported by the power train support system wo which couples the power train 220 to the chassis 210. It should be noted that the power train support system 100, alternatively, may couple the power train 220 to a vehicle body (not shown) or another carrier part of the vehicle 200. Thus, generally, the vehicle 200 may include a carrier part and the power train 220 is supported by the power train support system wo which couples the power train 220 to the carrier part of the vehicle. The following description, by way of example only and without being limited thereto, mostly refers to a chassis 210 as the carrier part.

The power train support system wo is only symbolically shown in FIG. 1 and includes a support frame 1 and a mounting device 2. Optionally, the power train support system wo may further include one or more of the following components shown in FIG. 1: a controller 4, an optical sensor 42, an acceleration sensor unit 44, and an input device 46.

As is shown in FIG. 1 and as will be explained in more detail by reference to FIGS. 2 to 5, the support frame 1 comprises a support structure lo for supporting a power train 220 with respect to a vertical direction Z and a first connection interface 12. The mounting device 2 includes a mounting interface 20 for mounting the mounting device 2 to the chassis 210 or, generally, to the carrier part of the vehicle 200, a second connection interface 22 mechanically connected to the first connection interface 12 of the support frame 1, and an actuation device 24 configured to move the second connection interface 22 relative to the mounting interface 20 along the vertical direction Z.

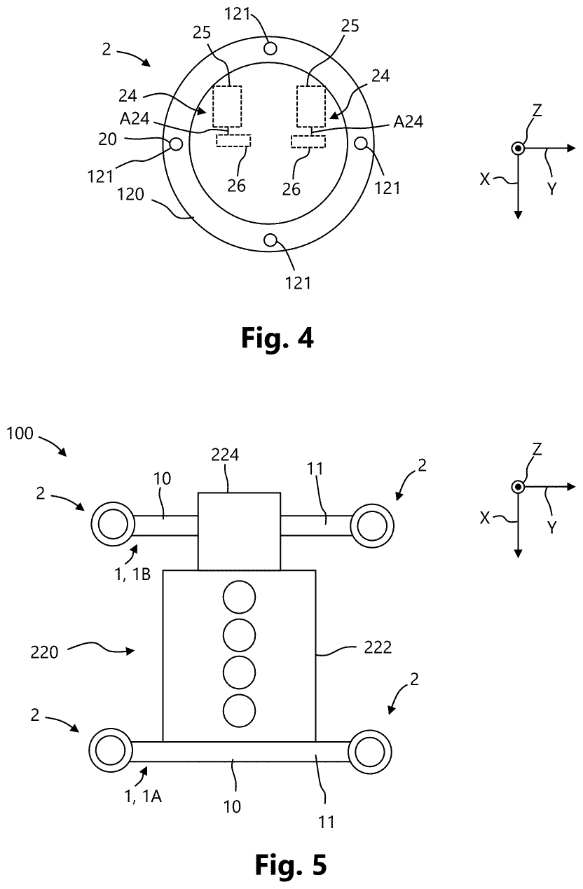

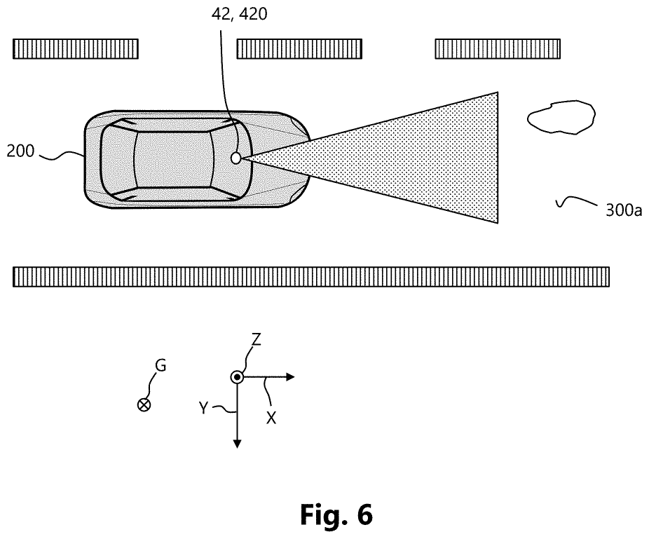

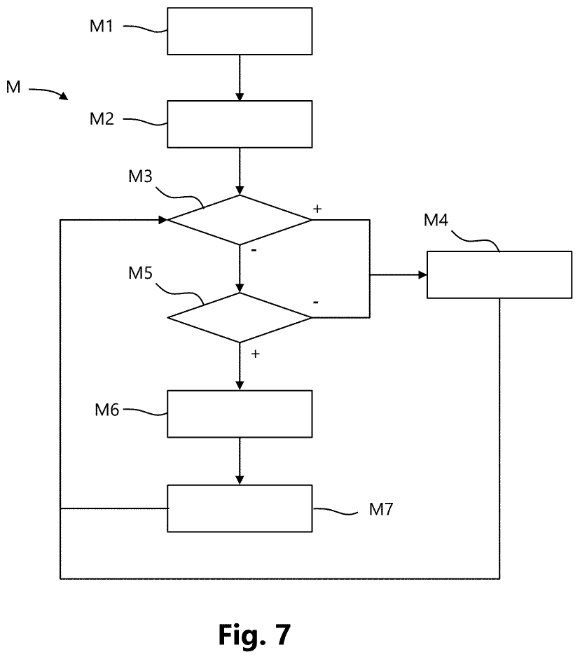

FIGS. 2 and 3 schematically show a cross-sectional view of the power train support system 100. FIG. 4 shows a top view of the mounting device 2. FIG. 5 shows a top view of the power train support system wo with the power train 220 mounted thereon.

As is schematically shown in FIGS. 2, 3, and 5, the support frame 1 may include a beam structure comprising at least one beam ii which may form the support structure 10. As exemplarily shown in FIGS. 2, 3, and 5, the beam 11 may extend along a lateral direction Y which is perpendicular to the vertical direction Z. The support structure 10, generally, is a structure to which the power train 220 can be fixed or which is configured to hold the power train 220. The first connection interface 12 may be formed by a recess or through hole 112, as is exemplarily shown in FIGS. 2 and 3. Optionally, the first connection interface 12 may be formed in or integrally with the beam structure.

The mounting device 2 may include a housing or carrier 102 defining an interior or void 103. The housing 102 may, for example, have a cylindrical shape, as is visible from FIG. 4. The mounting interface 20 may be realized as a flange portion 120 comprising a through hole 121 as exemplarily shown in FIGS. 2 to 4. For example, the mounting interface 20, in particular, the flange portion 120 may protrude sideward from the housing 102. As is visible from FIG. 4, the flange portion 120 may, for example, be ring shaped and surround the housing 102. For fixing the mounting device 2 to the carrier part, for example, to the chassis 210, a bolt or screw may be introduced through the through hole 121 to a receiving opening (not shown) of the carrier part.

The second connection interface 22 is movable relative to the mounting interface 20 with respect to the vertical direction, for example, along a middle axis defined by the housing 102. As exemplarily shown in FIGS. 2 and 3, the second connection interface 22 may be arranged within the interior 103 of the housing 102. Generally, the second connection interface 22 includes a coupling structure, e.g. in the form of an opening 122 as shown in FIGS. 2 and 3, wherein the coupling structure is configured to be coupled with the first connection interface 12 of the support frame 1. As exemplarily shown in FIGS. 2 and 3, the second connection interface 22 may include an elastically deformable holding member 23. The holding member 23 may include a flat or even plate portion 23A and a side portion 23B which is inclined relative to the plate portion 23A. The side portion 23B may, for example, have conical shape as exemplarily shown in FIGS. 2 and 3. The side portion 23B and optionally also the plate portion 23A may be made of a rubber material or an elastic plastic material. Alternatively, the plate portion 23A may be made of a rigid material, such as metal or a hard plastic material. The opening 122 may be formed in the holding member 23, in particular, in the plate portion 23A of the holding member 23 as shown in FIGS. 2 and 3.

As is further shown in FIGS. 2 and 3, the first and the second connection interfaces 12, 22 may be connected to each other by a shaft or bolt 3. The bolt 3 extends through the through hole 112 forming the first connection interface 12 where it is fixed, e.g. by means of a nut 113 which is screwed to a thread formed at least in an end portion of the bolt 13. The bolt 3 further extends into the opening 122 of the second connection interface 22 where it is fixed, too. For example, the bolt 13 can be friction fit into the opening 122 or adhesively fixed or bonded into the opening 122. Generally, the first and the second connection interfaces 12, 22 are coupled to each other, in particular, such that they remain stationary or in a fixed distance to each other with respect to the vertical direction Z.

Generally, the second connection interface 22 is movably coupled with the mounting interface 20. As exemplarily shown in FIGS. 2 and 3, this may be realized by coupling or fixing the side portion 23B of the holding member 23 to the housing 102. By deforming the holding member 23 along the vertical direction Z, e.g. by means of the actuation device 24 as will be explained below, the coupling structure or generally the second connection interface 22 is movable relative to the mounting interface 20 along the vertical direction Z.

The actuation device 24 may include an actuator coupled to or acting on the second connection interface 22 and a drive mechanism for moving the actuator. For example, the actuator may be formed by a cam 26 and the drive mechanism may be formed by an electric motor 25 as is exemplarily shown in FIGS. 2 to 4. The electric motor 25 is only shown in dashed lines in FIG. 4 as it is optionally arranged within the interior 103 of the housing 102. It may also be possible that the electric motor 25 is arranged at least partially on the exterior of the housing 102. Generally, the electric motor 25 is arranged stationary with respect to the mounting interface 20, e.g. by being fixed to the housing 102.

The cam 26 is coupled to the electric motor 25 and is rotatable about a rotational axis A24 by means of the electric motor 25. The cam 26 includes an actuation surface 26a for contacting and sliding on a contact surface 22a of the second connection interface 22. As is exemplarily shown in FIGS. 2 and 3, the actuation surface 26a may define an oval circumference of the cam 26 surrounding the rotational axis A24. It should be noted that other shapes of the actuation surface 26a are possible. For example, the actuation surface 26a may define a circular shape or another curved shape. Generally, the actuation surface 26a has a shape such that a distance v2 in the vertical direction Z between the rotational axis A24 and the contact surface 22a varies upon rotation of the cam 26 about the rotational axis A24, as is visible from a comparison of FIGS. 2 and 3.

As is schematically shown in FIGS. 2 and 3, the actuation surface 26a of the cam 26 is in contact with a contact surface 22a of the second connection interface 22. As exemplarily shown in FIGS. 2 and 3, the contact surface 22a may be formed by a surface of the plate portion 23A of the holding member 23. When the electric motor 25 rotates the cam 26, due to the shape of the actuation surface 26a, the cam 26 urges the second connection interface 22 along the vertical direction Z away from the rotational axis A24 by elastically deforming the holding member 23.

The embodiments are not limited to a configuration with an elastically deformable holding member 23 and a cam 26. For example, a screw drive may also be provided as an actuator which acts on a structure, e.g. a plate, forming the holding member and having the coupling structure, e.g. the opening 122. Thus, generally, the actuation device 24 is configured to move the second connection interface 22 relative to the mounting interface 20 along the vertical direction Z. When an elastically deforming holding member 23 is employed, as exemplarily shown in FIGS. 2 and 3, the actuation device 24 generally may be configured to deform the holding member 23 to move the second connection interface 22 along the vertical direction Z. As the first connection interface 12 of the support frame 1 is connected to the second connection interface 22 of the mounting device 2, the support frame 1 can be moved along the vertical direction Z by moving the second connection interface 22 relative to the mounting interface 20. The vertical direction Z may extend along or parallel to the direction of gravity G when the vehicle 200 having the power train support system loo is placed with its wheels 230 on a horizontal surface. Generally, by moving the second connection interface 22 relative to the mounting interface 20, the center of gravity of the vehicle 200 can be varied, in particular, raised or lowered relative to a road surface 300a.

FIG. 2 shows the support system loo in a first state, in which the holding member 23 is in a relaxed state. FIG. 3 shows the support system loo in a second state, in which the holding member 23 is in a tensioned state. In the relaxed state, the second connection interface 22 is positioned relative to the mounting interface 20 at a first distance d1 with respect to the vertical direction Z (FIG. 2). In the tensioned state, the actuation device 24 applies a force to the holding member 23 which deforms the holding member 23 so that the second connection interface 22 is positioned relative to the mounting interface 20 at a second distance d12 with respect to the vertical direction Z. In FIGS. 2 and 3, it is exemplarily shown that the second distance d2 is smaller than the first distance d1. As the first connection interface 12 of the support frame i and the second connection interface 22 and the actuation device 24 are positioned on opposite sides of the mounting interface 20, the second distance d12 between the first connection interface 12 and the mounting interface 20 is greater in the tensioned state than in the relaxed state, as is visible from FIGS. 2 and 3.

The power train support system wo as explained above may include one support frame 1 and one mounting device 2. Of course, the embodiments of the invention are not restricted to this configuration but may include more than one support frame 1 and more than one mounting device 2. For example, as shown in FIG. 5, the system wo may comprise a first support frame 1A and a second support frame 1B which is arranged parallel to the first support frame 1A distanced in a longitudinal direction X extending perpendicular to the lateral direction Y and the vertical direction Z. Each support frame 1A, 1B may comprise two first connection interfaces 12 (not visible in FIG. 5) arranged in opposite end portions of the support frames 1A, 1B. Thus, each end portion of the respective frame 1A, 1B may be coupled to a respective mounting device 2, as is schematically shown in FIG. 5.

Referring again to FIG. 1, the optional controller 4 may be an electronic controller including a processor (not shown), e.g. a CPU, an ASIC, a FPGA or similar, and a data memory (not shown) readable by the processor. The data memory may be a non-volatile memory such as a hard disc drive, a solid state drive or similar. The data memory may store a software program configured to cause the processor to generate output signals based on input signals. For example, the controller 4 may be configured to receive an input signal and to issue an actuation signal to actuate or operate the actuation device 24 in accordance with the input signal. Thus, the output or actuation signal generated by the controller 4 causes the actuation device 24 to move the second connection interface 22 along the vertical direction Z which results in a movement of the support frame 1 relative to the mounting interface 20 with respect to the chassis 210 or, generally, to the carrier part.

The optional optical sensor 42 is connected to the controller 4, for example, by a wired connection such as a data bus, and is configured to provide an input signal to the controller 4. The optical sensor 42 may, for example, be part of a camera 420 which is configured to scan a road surface 300a. As exemplarily shown in FIG. 6, the camera 420 may be mounted and arranged such that a road surface 300a of a road 30o ahead of the vehicle 200 is within the field of view of the optical sensor 42. The optical sensor 42 may be configured to detect surface features representing unevenness of the road surface 300a. For example, surface features may be formed by recesses, pot-holes, elevations, stones, obstacles and so on. The optical sensor 42 outputs detection data representing the detected surface features and provides the detection data as an input signal to the controller 4.

The optional acceleration sensor unit 44 is connected to the controller 4, for example, by a wired connection such as a data bus, and is configured to detect a lateral acceleration. The lateral acceleration includes an acceleration along the lateral direction Y which is perpendicular to the vertical direction Z and/or an acceleration around a vertical axis parallel to the vertical direction Z. Thus, lateral acceleration includes a roll moment and/or a yaw moment acting on the system loo or the vehicle 200. The acceleration sensor unit 44 outputs acceleration data representing the detected lateral acceleration and provides the acceleration data as an input signal to the controller 4.

The optional input device 46 is connected to the controller 4, for example, by a wired connection such as a data bus, and configured to receive a driver's input representing a desired position of the second connection interface 22 relative to the mounting interface 20. The input device 46, for example, may be a touch display to which the driver can enter the desired position or setting. The input device 46 is configured to output an input signal corresponding to the driver's input and provide it to the controller 4.

FIG. 7 exemplarily shows a flowchart of a method M for operating a power train support system 100 in a vehicle 200. The method M will be explained in the following by referring to the vehicle 200 and power train support system 100 described above. In particular, the controller 4 may be configured to cause the vehicle 200 or the power train support system 100 to perform the steps of the method M.

In first optional step Mi of the method, a driver's input representing a desired position of the second connection interface 22 relative to the mounting interface 20 may be received via the input device 46. For example, the driver may select between various setting modes such as “sport”, “comfort”, “custom” or similar. For these modes, pre-settings of the vertical position of the second connection interface 22 relative to the mounting interface 20 may be completely or partially pre-stored, for example, in the data memory of the controller 4. In step M2, the input device 46 issues an input signal to the controller 4.

Additionally or alternatively to steps Mi and M2, the method M may include step M3 in which surface features representing unevenness of the road surface 300a ahead of the vehicle 200 are detected, for example, by means of the optical sensor 42 which provides the detection data representing the detected surface features as an input signal to the controller 4. Step M3 further includes determining, e.g. by means of the controller 4, if the detected surface features indicate unevenness above a threshold predefined for the selected setting, i.e. if there are elevations or protrusions present on the road surface 300a having a height or depth above a threshold value. When it is determined in step M3 that the detected surface features indicate unevenness above the predefined threshold, as indicated by symbol “+” in FIG. 7, the method M proceeds with step M4. In step M4, the controller 4 does not issue an actuation signal for operating the actuation device 24 in order to maintain the position of the support frame 1 constant relative to the carrier part, e.g. the chassis 210 or the vehicle body.

When it is determined in step M3 that the detected surface features do not indicate unevenness above the predefined threshold, as indicated by symbol “−” in FIG. 7, the method M proceeds with step M5.

Step M5 may be performed additionally or alternatively to steps M1-M3. In step M5 the lateral acceleration of the vehicle 200 is captured, e.g. by means of the acceleration sensor unit 44. The acceleration sensor unit 44 captures the lateral acceleration and provides the detection data representing the lateral acceleration as an input signal to the controller 4. Step M5 further includes determining if the captured lateral acceleration is below a threshold value. When the captured lateral acceleration is above the threshold value, as indicated by symbol “−” in FIG. 7, the method M goes to step M4, in which, as described above, the position of the support frame 1 is kept constant. When the captured lateral acceleration is below the threshold value, as indicated by symbol “+” in FIG. 7, the method M goes to step M6.

In step M6, the controller 4 issues an actuation signal to the actuation device 24 of the power train support system wo. The controller 4 may issue the actuation signal in accordance with an input signal, which the controller 4 may receive as described above from the input device 46, the optical sensor 42, and/or from the acceleration sensor unit 44. In the process exemplarily shown in FIG. 7, the actuation signal is issued in accordance with the input signal received from the input device 46, when it has been determined in step M3 that the detected surface features indicate unevenness below the predefined threshold, and when it has been determined in step M5 that the lateral acceleration is below the predefined threshold.

In step M7, the second connection interface 22 is moved relative to the mounting interface 20 along the vertical direction Z by means of the actuation device 24 in accordance with the actuation signal.

The method M is not limited to the process described above. For example, the actuation signal may be issued or generated in step M6 based on the detected surface features detected in step M3. That is, the actuation device 24 may be caused by the controller 4 to move the second connection interface 22 such that the support frame 1 is moved away from the road surface 300a, when the detected surface features indicate unevenness above the predefined threshold and/or such that the support frame 1 is moved towards the road surface 300a, when the detected surface features indicate unevenness below the predefined threshold. Also in this case, the actuation signal may optionally be issued only when it is determined in step M5 that the detected lateral acceleration is below the predetermined acceleration threshold.

Further, as exemplarily shown in FIG. 7, steps M3-M7 may be performed in a loop. That is, after the actuation device 24 has moved the second connection interface 22 to move the support frame 1 relative to the carrier part, the method M may go back to step M3 to scan the road surface 300a so that, in the case that unevenness is detected, the actuation device 24 may be caused to raise the support frame 1 relative to the road surface. Similar, when the method M enters step M4, it may continue performing steps M3 and/or M5 to determine if the detected unevenness and/or the lateral acceleration has fallen below the respective thresholds.

The invention has been described in detail referring to exemplary embodiments. However, it will be appreciated by those of ordinary skill in the art that modifications to these embodiments may be made without deviating from the principles and central ideas of the invention, the scope of the invention defined in the claims, and equivalents thereto.

What is claimed is:

1. A power train support system comprising:
a support frame comprising a support structure configured to support a power train with respect to a vertical direction, and a first connection interface; and
a mounting device comprising a mounting interface at which the mounting device is mounted to a carrier part of a vehicle, a second connection interface mechanically connected to the first connection interface of the support frame, and an actuation device configured to move the second connection interface relative to the mounting interface along the vertical direction.

2. The power train support system according to claim 1, wherein the actuation device comprises an electric motor, and a cam coupled to the electric motor and configured to be rotatable about a rotational axis, wherein the cam includes an actuation surface in contact with a contact surface of the second connection interface, and wherein the actuation surface has a shape such that a distance in the vertical direction between the rotational axis and the contact surface varies based on rotation of the cam about the rotational axis.

3. The power train support system according to claim 1, wherein the second connection interface includes an elastically deformable holding member, and wherein the actuation device is configured to deform the holding member to move the second connection interface along the vertical direction.

4. The power train support system according to claim 3, wherein the holding member is deformable by the actuation device from a relaxed state to a tensioned state, wherein in the relaxed state the second connection interface is positioned relative to the mounting interface at a first distance with respect to the vertical direction, and wherein in the tensioned state the second connection interface is positioned relative to the mounting interface at a second distance with respect to the vertical direction. 5. The power train support system according to claim 1, wherein the first connection interface and the second connection interface are connected to each other by a shaft.

6. The power train support system according to claim 1, further comprising a controller configured to receive an input signal and to issue an actuation signal to actuate the actuation device in accordance with the input signal.

7. The power train support system according to claim 6, further comprising an optical sensor connected to the controller, wherein the optical sensor is configured to detect surface features representing unevenness of a road surface and to provide detection data representing the detected surface features as an input signal to the controller.

8. The power train support system according to claim 6, further comprising:
an acceleration sensor unit connected to the controller, wherein the acceleration sensor unit is configured to detect a lateral acceleration and to provide acceleration data representing the detected lateral acceleration as an input signal to the controller, wherein the lateral acceleration includes an acceleration along a lateral direction perpendicular to the vertical direction and/or an acceleration around a vertical axis parallel to the vertical direction;
wherein the controller is configured to issue the actuation signal only when the detected lateral acceleration is below a predetermined acceleration threshold.

9. The power train support system according to claim 6, further comprising an input device connected to the controller and configured to receive a user's input representing a desired position of the second connection interface relative to the mounting interface and issue an input signal corresponding to the user's input.

10. A vehicle comprising:
a carrier part;
a power train support system comprising:
a support frame comprising a support structure and a first connection interface; and
a mounting device comprising a mounting interface coupled to the carrier part, a second connection interface mechanically connected to the first connection interface of the support frame, and an actuation device configured to move the second connection interface relative to the mounting interface along a vertical direction;
a power train comprising an engine, and a transmission kinematically coupled to the engine, the power train being mounted to the support structure of the support frame, wherein the support structure is configured to support the power train with respect to a vertical direction; and
at least two wheels kinematically coupled to the power train.

11. The vehicle according to claim 10, wherein the actuation device comprises an electric motor, and a cam coupled to the electric motor and configured to be rotatable about a rotational axis, wherein the cam includes an actuation surface in contact with a contact surface of the second connection interface, and wherein the actuation surface has a shape such that a distance in the vertical direction between the rotational axis and the contact surface varies based on rotation of the cam about the rotational axis.

12. The vehicle according to claim 10, wherein the second connection interface includes an elastically deformable holding member, and wherein the actuation device is configured to deform the holding member to move the second connection interface along the vertical direction.

13. The vehicle according to claim 10, wherein the first connection interface and the second connection interface are connected to each other by a shaft.

14. The vehicle according to claim 10, further comprising a controller configured to receive an input signal and to issue an actuation signal to actuate the actuation device in accordance with the input signal.

15. The vehicle according to claim 10, wherein the carrier part comprises a chassis or a vehicle body.

16. A method for operating a power train support system in a vehicle, the power train support system comprising a support frame comprising a support structure and a first connection interface, and a mounting device comprising a mounting interface coupled to a carrier part of the vehicle, a second connection interface mechanically connected to the first connection interface of the support frame, and an actuation device, the method comprising:
issuing an actuation signal to the actuation device of the power train support system; and
moving the second connection interface relative to the mounting interface along a vertical direction using the actuation device in accordance with the actuation signal.

17. The method according to claim 16, further comprising:
receiving a user's input representing a desired position of the second connection interface relative to the mounting interface via an input device; and
issuing an input signal corresponding to the user's input, wherein the actuation signal is issued in accordance with the input signal.

18. The method according to claim 16, further comprising capturing a lateral acceleration of the vehicle, the lateral acceleration including an acceleration along a lateral direction perpendicular to the vertical direction and/or an acceleration around a vertical axis relative to the vertical direction, wherein the actuation signal is issued only in response to the captured lateral acceleration being below a predetermined acceleration threshold. 19. The method according to claim i6, further comprising detecting surface features representing unevenness of a road surface ahead of the vehicle, wherein the actuation signal is issued based on the detected surface features.

20. The method according to claim 19, wherein the actuation device moves the second connection interface such that the support frame is moved away from the road surface in response to the detected surface features indicating unevenness above a predefined threshold.
